(19) United States
(12) Patent Application Publication
(10) Pub. No.: US 2026/0337484 A1
(43) Pub. Date: Oct. 29, 2026

(54) FLUORESCENT LABELLING OF POLYMERS

(71) Applicant: The Provost, Fellows, Scholars and other members of Board of Trinity College Dublin, Dublin 2 (IE)

(72) Inventors: Ramesh Babu PADAMATI, Dublin 2 (IE); Ritupama DUARAH, Dublin 2 (IE)

(21) Appl. No.: 19/102,427

(22) PCT Filed: Aug. 9, 2023
(86) PCT No.: PCT/EP2023/072099

§ 371 Date: Feb. 10, 2025

(30) Foreign Application Priority Data
Aug. 10, 2022 (GB) 2211716.2

(51) Int. Cl. C09K 11/65; B82Y 20/00

(52) U.S. Cl. CPC C09K 11/65; B82Y 20/00

(57) ABSTRACT

The present invention relates to methods of preparing fluorescent labelled polymers, as well as labelled polymers prepared thereby. The fluorescent labelling can be carried out using carbon nanodots derived from natural resources such as fruit peels and plant extracts, and from recycled sources such as recovered raw materials from plastic waste. The labelled polymers can be easily identified and separated from mixed plastic wastes. In aspects, the fluorescent labelling can be used to estimate the amount of the labelled polymer, providing an indication of natural/recycled content, and facilitating its use in compliance methodologies.

The present invention relates to methods of preparing fluorescent labelled polymers, as well as labelled polymers prepared thereby. The fluorescent labelling can be carried out using carbon nanodots derived from natural resources such as fruit peels and plant extracts, and from recycled sources such as recovered raw materials from plastic waste. The labelled polymers can be easily identified and separated from mixed plastic wastes. In aspects, the fluorescent labelling can be used to estimate the amount of the labelled polymer, providing an indication of naturally-derived or recoverable content, and facilitating its use in compliance methodologies.

### BACKGROUND

Bioplastics and biodegradable polymers are of increasing interest as a solution to the current problems associated with waste plastics derived from fossil fuels. Recyclable bioplastics are increasingly being used for consumer products and packaging, such as plastic bags, food packaging etc. However, despite being recyclable, much of this bioplastic waste still ends up in landfill, due to the poor adoption of existing sorting technologies, and the low volumes of bioplastics within existing plastic waste streams, which make complex sorting technologies undesirable due to the limited amounts of materials recoverable. Together, these problems have hampered the adoption of bioplastics for many consumer-led applications and, even where they are adopted, limit their circularity when otherwise recyclable bioplastic materials end up in landfill alongside fossil-based wastes.

Recycling plastics not only reduces environmental pollution, but also allows valuable raw materials to be reused. The UK Government recently introduced a new UK Plastic Packaging Tax to encourage the use of materials with at least 30% of recycled plastic. However, assessing the recycled content of plastics is currently difficult, with no widely-adopted or standard technologies in place. While inorganic tracer materials and phosphors are known for fluorescent labelling of plastics, due to their potential toxicity, these materials are unsuitable for direct contact with foodstuffs or food packaging and are generally applied as inks to labels glued or affixed to the plastic/polymer materials. After sorting, the labels must then be removed and disposed of as an additional step in any recycling process, increasing the complexity of the sorting technique, and adding to the amount of non-recyclable waste produced. Other sorting methodologies suffer from a range of drawbacks; for instance, conventional optical (NIR) methods and physico-chemical (floating, electrostatic) methods have difficulties in distinguishing dark coloured polymers, and those with similar densities, respectively, from mixed polymer streams.

It would be beneficial to provide a method of labelling polymer and plastic materials. In particular, it would be beneficial to provide a method of labelling polymer materials to facilitate their sorting, which obviates or mitigates some of the disadvantages associated with prior art techniques. Such methods could allow specific materials, such as recyclable and/or naturally-derived materials to be identified and segregated from bulk waste streams, while providing advantages in terms of reduced complexity, avoidance of toxic materials, and/or increased recovery of reusable/recyclable materials. It would be beneficial to provide a method of labelling polymer and plastic materials which could allow wastes with a range of colours, and in particular dark-coloured polymers, as well as polymers of similar densities to be segregated.

It would also be beneficial to provide a method of labelling polymer materials to facilitate the assessment of their content, such as, for example, an assessment of the content which is biodegradable and/or recyclable. Such methodologies would be useful in the areas of environmental compliance, and/or to increase recovery of valuable reusable materials from waste streams.

### SUMMARY OF THE INVENTION

According to a first aspect of the present invention there is provided a method of preparing a fluorescent labelled polymer, the method comprising:
providing fluorescent carbon nanodots, and
incorporating the fluorescent carbon nanodots into the polymer, wherein the fluorescent carbon nanodots are prepared from a natural or recoverable resource.

Carbon nanodots (CDs) are a class of nanoparticles with particles sizes of less than 10 nm. Carbon nanodots have received attention due to their ease of manufacture, and their fluorescence characteristics. The present invention has advantageously found that carbon nanodots can be incorporated into polymers to fluorescently label them, allowing for a host of potential applications in identifying and sorting polymer waste and estimating recycled content of plastics.

In an embodiment, the fluorescent carbon nanodots are incorporated into the polymer by melt processing, solution casting or in-situ polymerisation. The fluorescent carbon nanodots can be incorporated into the polymer by known melt-processing/melt-blending, solution casting or in-situ polymerisation techniques. Melt-processing or melt-blending techniques typically involve melting and subsequently solidifying the polymer and any additional components or additives. In this case, the carbon nanodots are melt-mixed with the polymer and extruded or pressed to form the final polymer composite material. Alternatively, the carbon nanodots and polymer can be dry-mixed before being melted and extruded or pressed. Advantageously, melt blending is an environmentally benign technique as it does not require the use of organic solvents, thereby increasing overall the environmental credentials of the invention. Solution casting typically involves dissolving or dispersing the polymer and any additional components or additives in solution, and then coating on or dispersing in a substrate or mould, before drying to prepare the final polymer composite material. In-situ polymerisation typically involves dispersion of additives in liquid monomer(s) or in the presence of solvent to form a homogeneous mixture, followed by the application of a suitable heat source, initiators, light, etc, to form the final polymer composite material.

In an embodiment, the fluorescent carbon nanodots are incorporated into the polymer by melt processing in a melt-mixer.

In an embodiment, the fluorescent carbon nanodots are incorporated into the polymer by solution casting.

In an embodiment, the fluorescent carbon nanodots are incorporated into the polymer by in-situ polymerisation.

In an embodiment, the fluorescent carbon nanodots are mixed with an organic or inorganic filler material before being incorporated into the polymer. In this embodiment, the carbon nanodots are comprised within a filler material, which is melt-mixed with the polymer. As would be apparent to one of skill in the art, the polymer can be melted and then mixed with the filler material, or the polymer and filler can be dry mixed, and then melted and pressed or shaped to form the final product. In each case, additional components or additives can be incorporated as necessary, either in the composite or alongside the composite and polymer, to make up the final polymer composition, as would be apparent to one skilled in the art.

Alternatively, the fluorescent carbon nanodots are incorporated directly into the polymer. In this embodiment, the fluorescent carbon nanodots are not part of a composite filler material, but are directly incorporated into the polymer along with any other desired additives or components. Again, this can be achieved by melt-mixing the carbon nanodot material with the polymer.

The fluorescent carbon nanodots are prepared from a natural or recoverable resource.

According to the invention, a natural or recoverable resource is one which is biological in original, such as fruit peels, leaves, plant extracts etc., or one which is recovered or recoverable from a waste material, e.g., such as terephthalic acid from PET.

Advantageously, preparing carbon nanodots from a natural or recoverable resource increases the percentage of the overall polymer which is from natural or renewable resources. Unlike existing rare-earth tracers or non-bio-derived carbon nanodots, bio-based fluorescent carbon nanodots have inherent biocompatibility, facilitating their use in food packaging and similar applications. The inventors have also advantageously determined that the addition of these carbon nanodots as fluorescent labels into polymers does not affect the degradation of biopolymers and may in some cases, increase the rate of biodegradation. This is in stark contrast to known tracer materials based on rare-earth metals, which are typically printed onto labels to avoid contact with foodstuffs, and then removed prior to recycling.

In an embodiment, the natural or recoverable resource is fruit peel. Suitable fruit peels include, but are not limited to, lemons, apples, oranges, pomegranate, grapefruit, mango, and kiwi. In an embodiment, the fruit peel is orange peel waste. In the juicing industry, the peel waste accounts for approximately 50% of the weight of the orange used. This orange peel waste is typically burned, producing carbon dioxide and other greenhouse gases, or sent to landfill, where permeation from the rotting peels can damage plant life. Due to its ready availability, and the advantages of utilising an otherwise waste product, orange peel is a particularly suitable natural resource for use in the preparation of carbon dots according to the invention.

In an embodiment, the natural or recoverable resource is a plant leaf, frond or husk, such as betel leaf, coriander leaf, tobacco leaf, neem, hyacinth, curry leaf, Curcuma longa (turmeric) leaf, Lawsonia inermis (henna) leaf, bougainvillea leaf, or chrysanthemum buds, date palm frond, coconut husk or rice husk.

In an embodiment, the natural or recoverable resource is citric acid. Citric acid is a cost-effective, commercially bio-produced organic acid with annual production estimated at 1.75 million tons in 2011.

The natural or recoverable resource may be waste residues, from tea, coffee, bamboo, etc.

In an embodiment, the natural or recoverable resource is recovered or recoverable from a waste material. Examples include, but are not limited to, terephthalic acid and Delactosed Whey Permeate (DLP). Terephthalic acid is recoverable from PET plastics and fabrics. Delactosed whey permeate is a side stream of whey processing.

In an embodiment, the natural or recoverable resource is selected from fruit peels, plant leaves, plant extracts, plant fronds or husks, or is terephthalic acid or Delactosed Whey Permeate (DLP).

In an embodiment, the natural or recoverable resource is selected from citric acid, orange peel extract, terephthalic acid and DLP.

In an embodiment, the natural or recoverable resource is selected from orange peel extract, terephthalic acid and DLP.

In an embodiment, the preparation of the fluorescent carbon nanodots is carried out via a hydrothermal method. Hydrothermal methods involve heating the raw/starting materials under high pressure, for instance using an autoclave or high-pressure reactor, where the combination of the temperature and increase in pressure drive product formation. Advantageously, hydrothermal methods typically use green synthesis protocols, with water as the primary solvent, and due to their facile ‘one-pot’ nature, are suitable for scale up.

In an embodiment, the hydrothermal method comprises heating the raw materials in a high-pressure reactor or autoclave at between 100-300 °C.

In an embodiment, the hydrothermal method comprises heating the raw material in a high-pressure reactor at a temperature of from 100 to 200 °C.

The raw materials may be heated in a high-pressure reactor or autoclave for from 10 minutes to 4 hours, or from 2 hours to 4 hours.

In an embodiment, the hydrothermal method comprises heating the raw materials in a high-pressure reactor or autoclave at between 100-300 °C, or from 150-200 °C When the raw materials are heated at between 100-300 °C, this can be for from 2 hours to 7 hours. When the raw materials are heated at between 150-200 °C, this can be for 2.5 to 4.5 hours, or from 3 to 4 hours. In an embodiment, the hydrothermal method comprises heating the raw materials in a high-pressure reactor or autoclave at between 100 to 200 °C for from 2 hours to 4 hours.

The carbon nanodots may be obtained as a viscous liquid, and can be freeze-dried to improve handling and/or storage.

The carbon nanodots exhibit fluorescence under UV light in both solution and freeze-dried forms.

The raw material may be citric acid, orange peel extract or terephthalic acid. The terephthalic acid may be derived from depolymerisation of PET.

In an embodiment, the polymer is a biopolymer. Biopolymers are known in the art and include, but are not limited to polylactic acid (PLA), polybutylene succinate (PBS), polyhydroxy butyrate (PHBV), Poly(butylene succinate-co-butylene adipate) (PBSA), and poly caprolactone (PCL).

In an embodiment, the biopolymer is selected from polylactic acid, polybutylene succinate and polyhydroxy butyrate.

According to an aspect of the invention there is provided a fluorescent labelled polymer, wherein the fluorescent labelled polymer comprises fluorescent carbon nanodots prepared from a natural or recoverable resource.

The natural or recoverable resource may be selected from citric acid, orange peel extract and terephthalic acid. The natural or recoverable resource may be selected from orange peel extract and terephthalic acid.

The polymer may be a biopolymer such as polylactic acid (PLA), polybutylene succinate (PBS), polyhydroxy butyrate (PHBV), Poly(butylene succinate-co-butylene adipate) (PBSA), and poly caprolactone (PCL).

In an embodiment, the biopolymer is selected from polylactic acid, polybutylene succinate and polyhydroxy butyrate.

Whilst biopolymers are particularly desired for use in the present invention, the method is not so limited, and the polymer may be a non-bio-polymer, such as a polyolefin, polyester, polystyrene, polyurethane, polyethylene furanoate, Nylon, polyether amide, polycarbonate, silicone, epoxy, polyvinyl chloride (PVC), ABS polymer, polybutadiene rubber, cellulose acetate and other cellulose derivatives of fossil-based resources.

According to an aspect of the invention there is provided a fluorescent composite material comprising fluorescent carbon nanodots and an inorganic or organic filler, wherein the fluorescent carbon nanodots have been prepared from a natural or recoverable resource. The natural or recoverable resource may be selected from citric acid, orange peel extract or terephthalic acid. The natural or recoverable resource may be selected from orange peel extract or terephthalic acid.

The fluorescent composite material is suitable for use as a polymer filler. Advantageously, the fluorescent composite material imparts fluorescence characteristics on the polymer, and can be readily incorporated into a polymer, for instance using melt mixing, solution casting or in-situ polymerisation techniques. The inventors have demonstrated that polymers incorporating the fluorescent composite material exhibit fluorescence, while maintaining the mechanical strength characteristics of the corresponding non-fluorescent polymer (i.e., without the fluorescent carbon nanodots). The inventors have determined that when the fluorescent composite material is incorporated into biodegradable polymers, the rate of biodegradation is the same or even improved relative to the non-fluorescent polymer counterparts. These results demonstrate that the fluorescent carbon nanodots can be used in scalable methods to prepare composite materials which can impart fluorescent characteristics on the polymer, without any negative effect on the mechanical or biodegradation characteristics.

According to an aspect of the invention, there is provided a method of identifying a polymer, the method comprising exposing the fluorescent labelled polymer according to the invention to UV light, and visualising the fluorescence via the naked eye or spectrometry.

In this method, the presence of fluorescence indicates the presence of the fluorescent carbon nanodots, and can be used to identify those polymers which comprise fluorescent carbon nanodots. In this way, the polymers can be used to label or ‘tag’ specific polymers, with a host of potential applications, including in waste sorting techniques, as well as in tracking and compliance.

In embodiments, the method comprises identifying a fluorescent labelled polymer in a mixed waste stream. In this way, labelled polymers can be easily segregated from waste streams, for instance, to facilitate their biodegradation or recycling.

According to an aspect of the invention, there is provided a method of assessing the naturally-derived or recoverable content of a polymer, the method comprising exposing the fluorescent labelled polymer hereinbefore described, or a mixture of polymers including same, to UV light, and comparing the absorbance spectrum with a control spectrum to assess the labelled content. The inventors have advantageously determined that the UV absorbance of the labelled polymer correlates with the amount of labelled polymer, such that a UV absorbance spectrum can be used to assess the amount of labelled polymer present. In this way, a comparison of a control UV spectrum prepared with known amounts of labelled polymer, with an unknown quantity of polymer, for instance, in a mixed waste stream, can be used to assess the amount of polymer present. In embodiments, therefore comparing the absorbance spectrum with a control spectrum can give an assessment of the biodegradable content.

In an embodiment, the fluorescent labelled polymer is a biopolymer, and comparing the absorbance spectrum with a control spectrum gives an assessment of the biodegradable content. As one would appreciate, this can be useful in a variety of applications, such as for assessing compliance with regulations governing the content of plastics/polymers, for instance, by determining the amount of polymer derived from recyclable or bio-based sources in a mixed waste stream. This method comprises preparing control samples of polymers with known carbon nanodot (CD) content, measuring the absorbance of each sample, and using these to prepare a calibration curve. In this way, the concentration of carbon nanodots in an unknown sample can be determined by comparing the absorbance of the unknown sample against the calibration curve. This could be used, for instance, to determine whether the unknown sample has a threshold amount of recycled or biodegradable content (inferred by the presence of the carbon nanodots) to ensure compliance with regulatory requirements.

In an embodiment, the fluorescent labelled polymer is a polymer prepared from a recoverable resource, and the method can be used to assess the recoverable content. This can be useful where, for example, raw materials such as terephthalic acid are recoverable from the polymers.

According to an aspect of the invention, there is provided a method of preparing a fluorescent composite for use as a polymer filler, the method comprising:
providing fluorescent carbon nanodots from a natural or recoverable resource, and
mixing the fluorescent carbon nanodots with an inorganic or organic filler material to prepare a fluorescent composite.

In an embodiment, the inorganic material is selected from calcium carbonate, talc, mica, kaolin, magnesium hydroxide, wollastonite (CaSiO₃), glass, silica, zinc oxide, titanium oxide, iron oxide, magnesium carbonate, Polyhedral oligomeric silsesquioxanes (POSS), zinc carbonate, calcium sulphate, 2D materials such as graphene and hexagonal boron nitride (hBN), or a nanoclay composite. Suitable nanoclay composites are known in the art, such as Cloisite 30B™, sold by BYK additives, montmorillonite, and halloysite.

In an embodiment, the organic material is selected from carbon black, wood flour, cork flour, and natural fibres.

In an embodiment, the filler is a nanoclay.

### DETAILED DESCRIPTION

The invention will now be described by reference to the Figures in which:

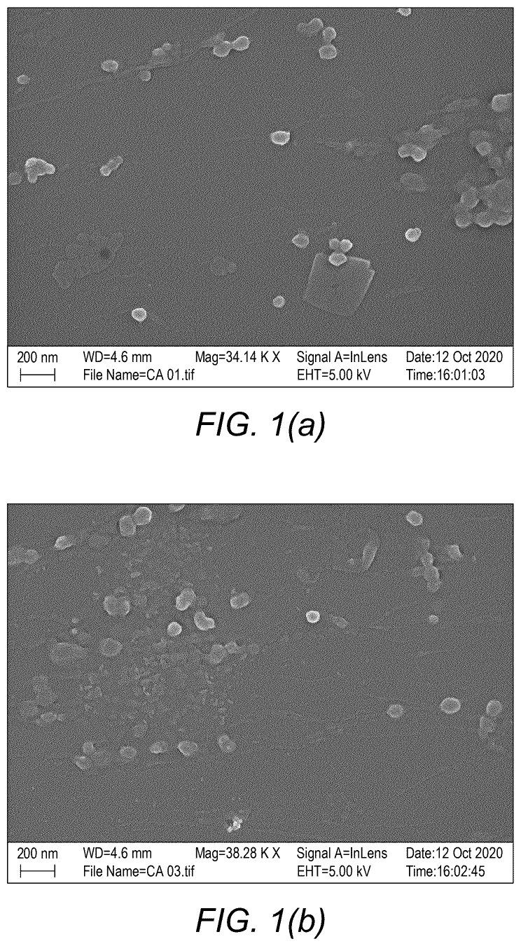

FIG. 1 shows SEM imaging of citric acid based nanodots prepared according to Example 1.1 at (a) 34.14 KX and (b) 38.28 KX;

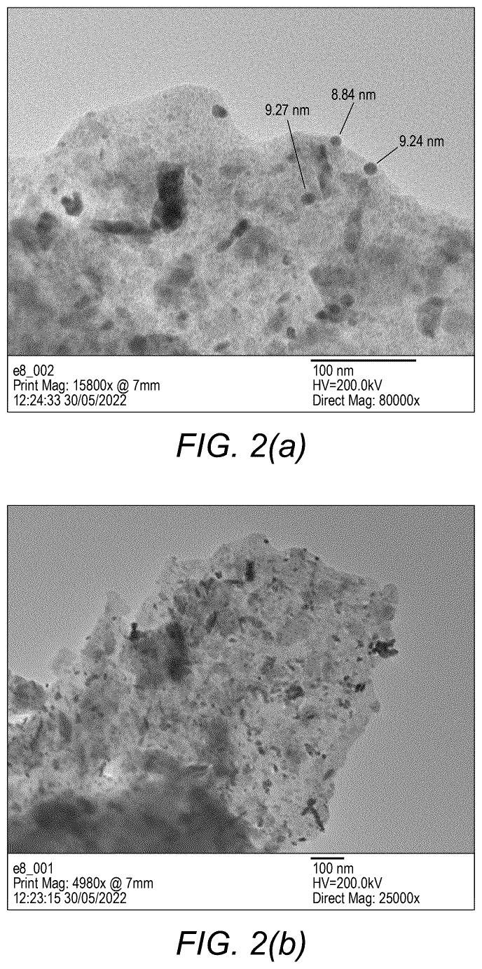

FIG. 2 shows TEM image of (a) citric acid-based CD (size<10 nm dimension) prepared according to Example 1.1 and (b) particle distribution of citric acid-based CD;

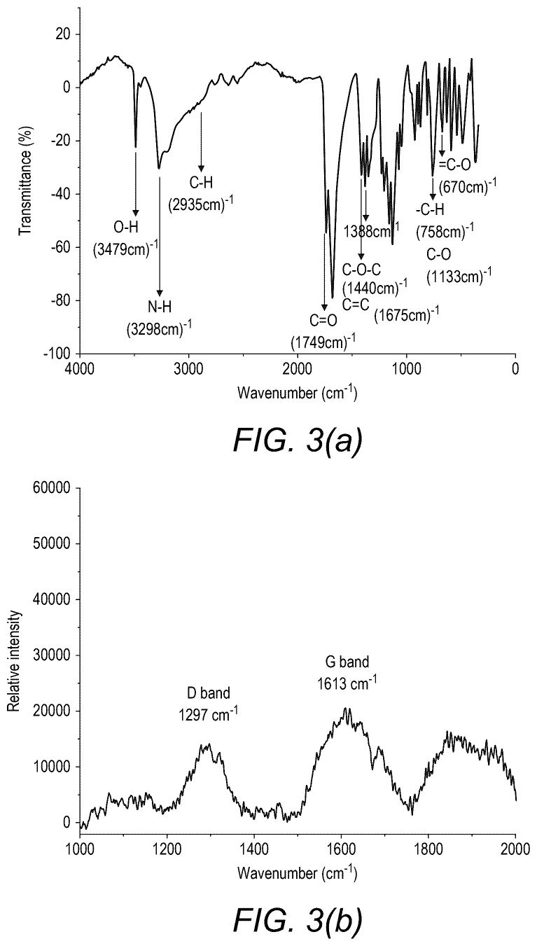

FIG. 3 shows (a) FTIR spectrum and (b) Raman spectrum of citric acid based nanodots prepared according to Example 1.1;

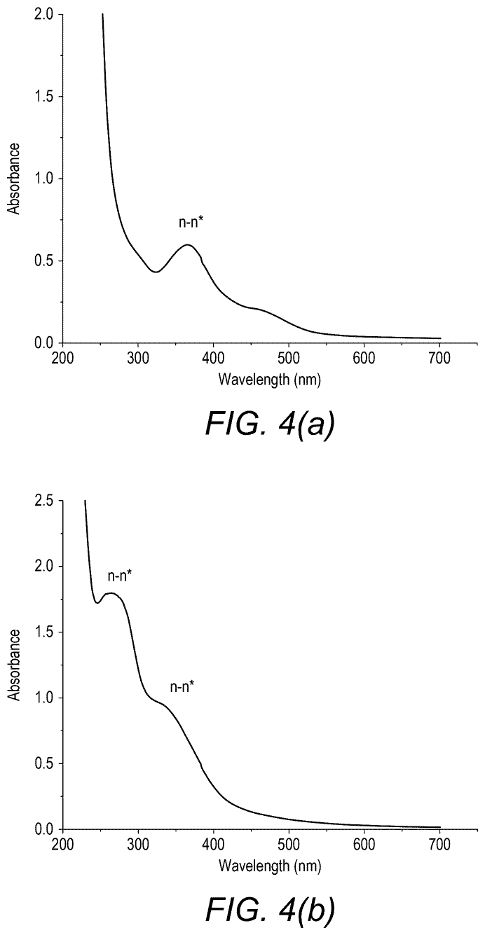

FIG. 4 shows the UV-VIS spectrum of (a) citric acid-based CDs prepared in Example 1.1 and (b) orange peel-based CDs prepared in Example 1.2;

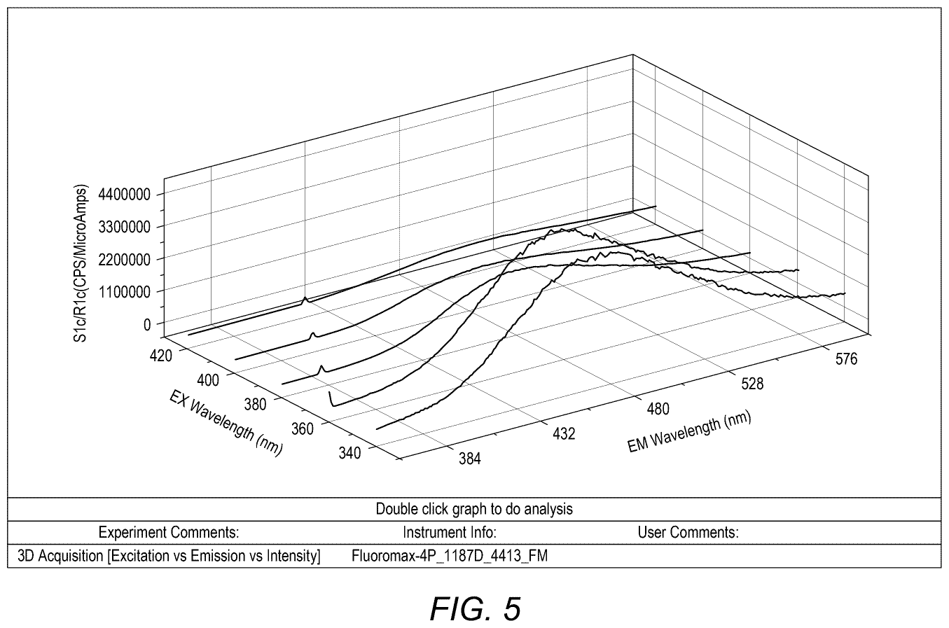

FIG. 5 shows the photoluminescence spectra of citric acid-based CDs prepared in Example 1.1;

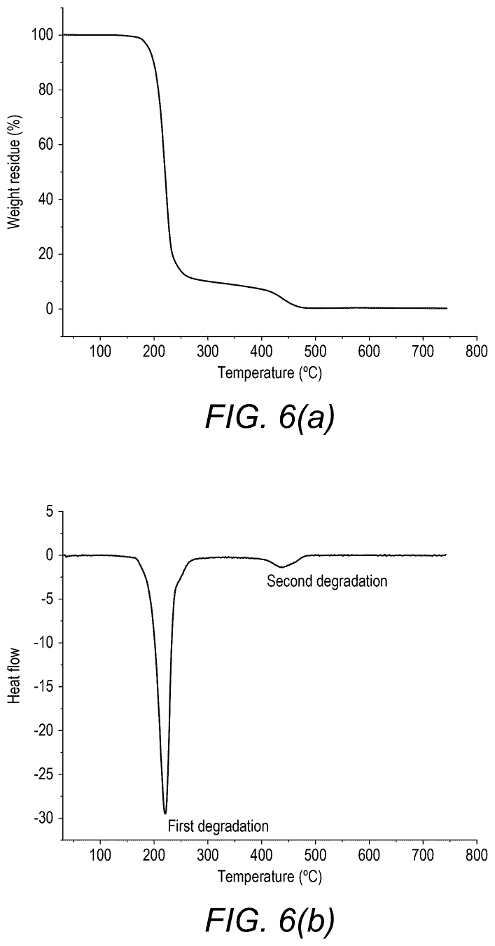

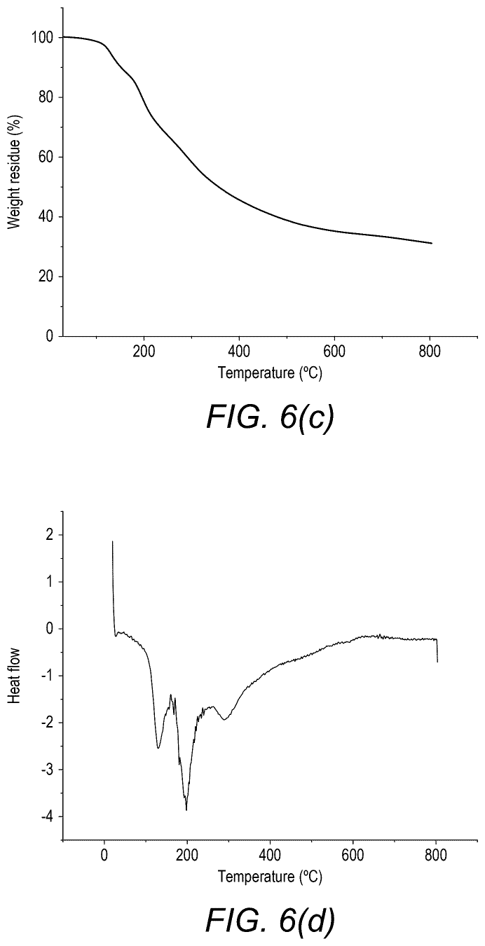

FIG. 6 shows (a) TGA thermogram of citric acid-based CDs; (b) DGT curve of citric acid-based CDs; (c) TGA thermogram of orange peel-based CDs; and (d) DGT curve of orange peel-based CDs;

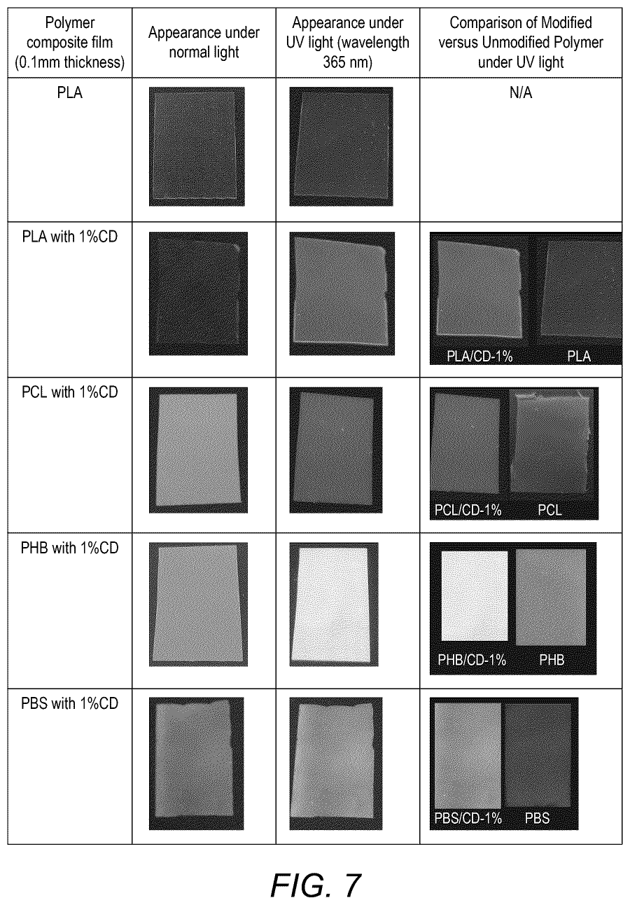

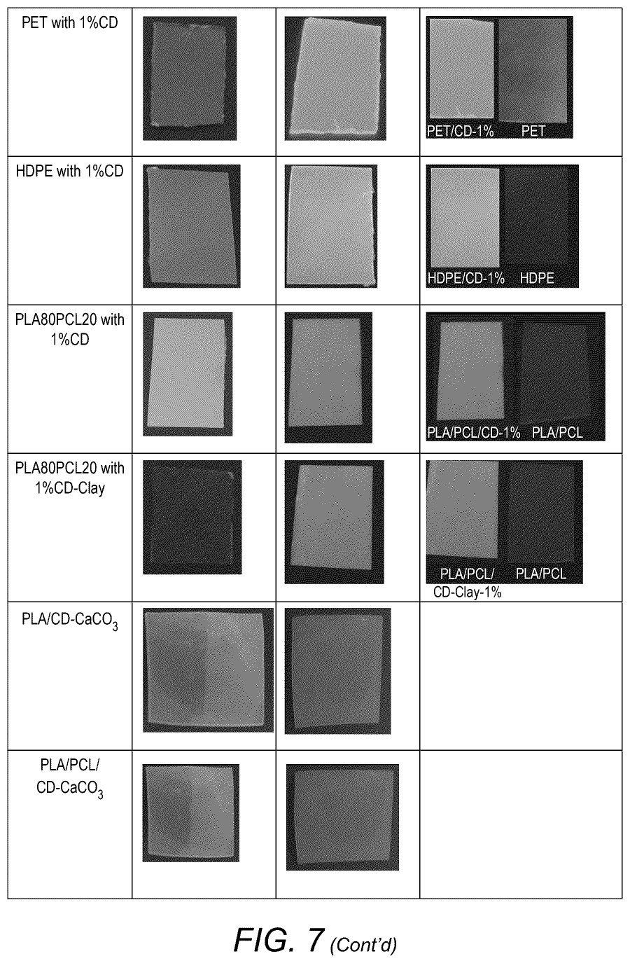

FIG. 7 shows the effect of the incorporation of fluorescent carbon nanodots into polymer composites on their appearance under normal and UV light;

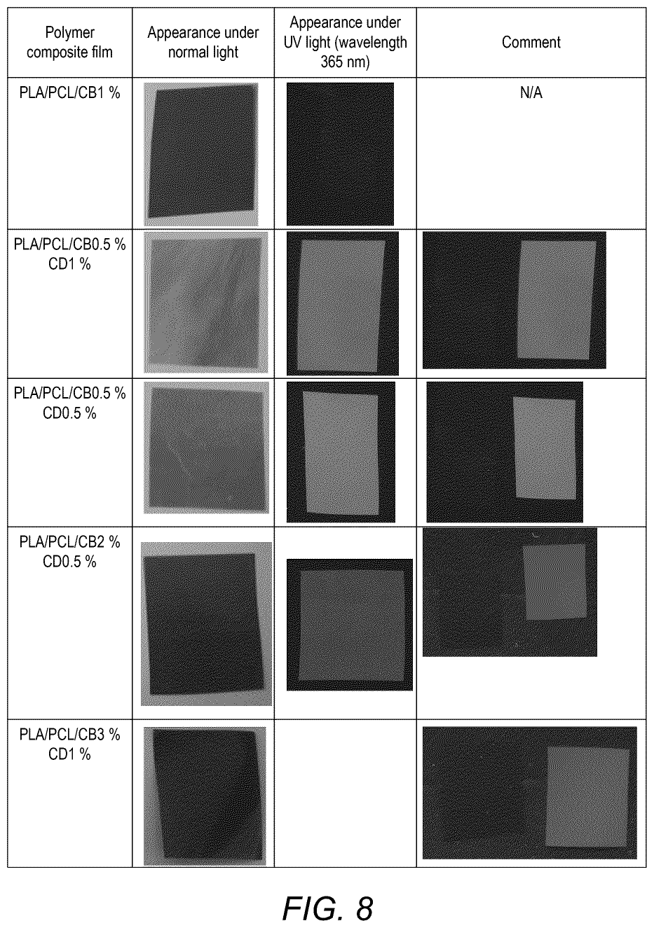

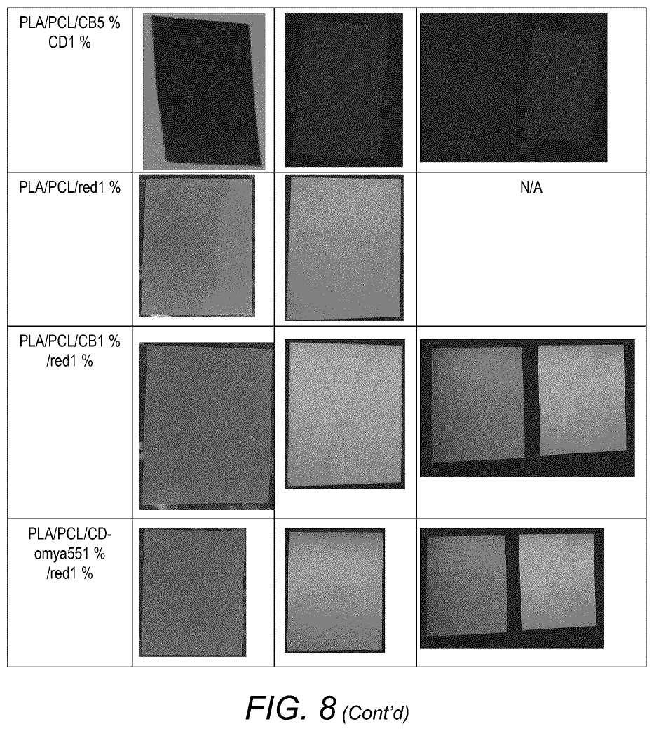

FIG. 8 shows the effect of the incorporation of fluorescent carbon nanodots into black or coloured polymer composite materials on their appearance under normal and UV light;

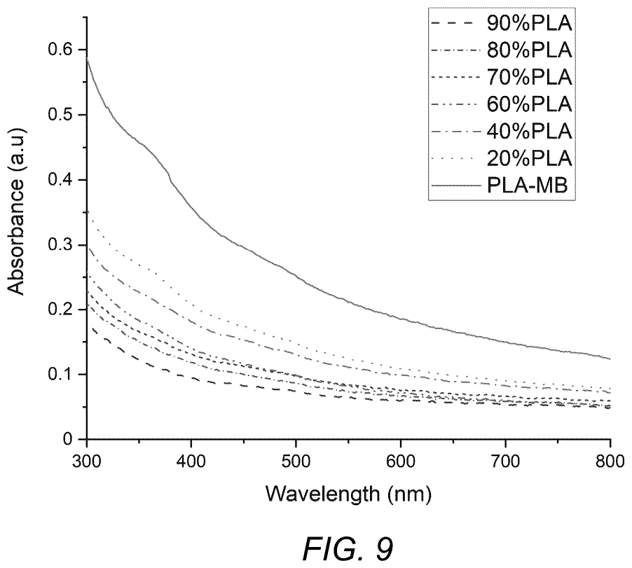

FIG. 9 shows UV absorbance for PLA composites with various amounts of MB according to Example 6;

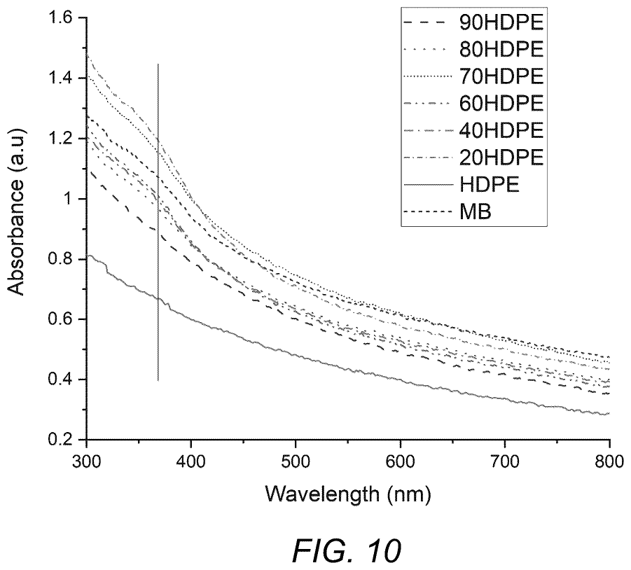

FIG. 10 shows UV absorbance for HDPE composites with various amounts of MB according to Example 6.

### EXAMPLES

The invention will now be described by way to reference to the following illustrative examples.

### Methodology:

SEM imaging was carried out as follows:

Scanning electron microscope (SEM) images of carbon dots were obtained using a high-resolution field emission Zeiss™ Ultra Plus-SEM (Carl Zeiss AG, Oberkochen, Germany) using an In-lens detector with an accelerating voltage of 5 kV at a working distance of 5 mm. Prior to imaging, CD placed onto the SEM stubs and sputtered with gold/palladium (80/20 ratio) for 10 s.

TEM imaging was carried out as follows:

For transmission electron microscopic (TEM) study, a drop of dilute CD aqueous solution was placed on a copper grid and dried before being transferred into the TEM sample chamber. CD was dispersed in distilled water and sonicated for 20 min, following which a drop of CD solution was placed on the copper grid. Subsequently, the TEM images were acquired on a JEOL 2100 LaB TEM operating at a beam voltage of 200 kV.

FTIR was carried out as follows:

Fourier transform infrared (FTIR) spectra of CD were recorded on a PerkinElmer™ Spectrum 100 equipped with a universal total reflectance (Diamond/KRS-5 sandwich assembly) sampling accessory. The spectra were recorded from 4,000 to 400 cm⁻¹, with 16 accumulations and a resolution of 4 cm-1.

Raman Imaging was carried out using a LabRAM ARAMIS system (HORIBA Jobin Yvon) at an excitation wavelength of 532 nm.

UV-VIS spectrometry was carried out as follows:

The UV-visible absorption spectra of CD were recorded using a Perkin Elmer Lambda 1050 UV-Vis NIR (190 nm-3300 nm) spectrophotometer in aqueous solution.

Photoluminescence Spectroscopy was carried out as follows:

Photoluminescence (PL) behaviour of CD was studied using a Perkin Elmer Lambda 1050 UV-Vis NIR (190 nm-3300 nm) spectrophotometer in aqueous solution.

Thermogravimetric Analysis (TGA) was carried out as follows:

The thermal stability and decomposition profile of CD was analysed using a thermogravimetric analyser (Perkin Elmer Pyris 1, USA). CD was dried and weighed (2-5 mg) and placed in a platinum pan and heated from 30 °C to 800 °C at a rate of 10 °C/min under nitrogen atmosphere flow of 20 mL/min.

### Example 1: Synthesis of Carbon Nanodots from Natural or Recoverable Resources

### Example 1.1 Citric Acid

N-doped citric acid-based carbon nanodot(s) (CD) were synthesised by a green, facile, one-step hydrothermal technique in a high-pressure reactor, as follows: Citric acid (Sigma Aldrich, ACS reagent, ≥99.5%, mol. Wt. 192.12) (60 g) and 6 mL of 5 mM of ethylenediamine were dissolved in tap water (1,000 mL) in a stainless-steel high-pressure reactor and heated at a constant temperature of 150 °C for 3 hours. At the end of 3 hours, a brown liquid product was obtained, and cooled at room temperature. The liquid was filtered through a Whatman filter paper (grade 3, 90 mm diameter) to remove any solid impurities like char. Finally, the CD solution was freeze dried to obtain a highly fluorescent CD with a total of 93-94% yield (56 g).

The synthesized citric acid CDs were viewed under normal light and UV light (wavelength 365 nm) and exhibited blue fluorescence under UV light in both solution and freeze-dried forms. The CD solution changed from light brown to bright blue after excitation by UV light, indicating that it is longer wavelength-absorptive.

The citric acid-based CDs were analysed by SEM, TEM, FTIR, Raman spectroscopy, UV-vis spectroscopy, photoluminescence spectroscopy in Examples 2.1-2.3.

### Example 1.2 Orange Peel Extract

CDs from orange peel extracts were synthesised by a green, facile, one-step hydrothermal technique in a high-pressure reactor, as follows. 85 g orange peel waste was weighed and mixed with 360 ml water and ground into a paste and heated at 60 °C under stirring for 30 min. The mixture was then filtered under a vacuum pump to obtain 270 ml of filtrate—this filtrate was used as a carbohydrate rich bio-precursor for the preparation of CDs.

The filtrate was dissolved in 240 ml water in a stainless-steel high-pressure reactor, heated at a constant temperature of 150 °C for 3 hours. A dark brown CD solution was obtained, which was cooled at room temperature; and the residue was separated by filtration, followed by the addition of 50 mL ethanol. The CD solution was centrifugated two times, for 15 minutes each, at 3000 rpm under ambient conditions. After centrifugation, the CD solution was freeze-dried to obtain a dark brown, thick, viscous mass of dried CD.

The synthesized orange peel-based CDs were viewed under normal light and UV light (wavelength 365 nm) and exhibited blue fluorescence under UV light in both solution and freeze-dried forms. The CDs were characterised by UV-VIS spectroscopy in Example 2.3.

### Example 1.3: Terephthalic Acid

### 1.3.1 Recovery of Terephthalic Acid from PET Fabric

30 g polyethylene terephthalate (PET) fabric was taken in 300 ml of water and subjected to hydrolysis reaction in a stainless-steel high-pressure reactor at 250 °C for 30 min. After the reaction was completed, the product comprised of terephthalic acid (solid content) and ethylene glycol (liquid content). The entire reaction mixture was then utilized to synthesize novel N-doped terephthalic acid-based carbon nanodots using a one-step, green hydrothermal technique.

### 1.3.2 Preparation of Terephthalic Acid-Based Carbon Nanodots

The solution was neutralized with 200 ml of 0.5M NaOH solution to solubilize the terephthalic present in the reaction mixture and 6 ml of 5 mM of ethylenediamine was added. The entire solution was transferred to a stainless-steel high-pressure reactor, which was heated to 180 °C and kept for 3.5 h. A yellow liquid product was obtained at the end of 3.5 hours, which was cooled to room temperature. The solution was filtered using Whatman filter paper (grade 3, 90 mm diameter, to obtain a bright fluorescent carbon nanodot solution. Finally, the carbon nanodot solution was freeze dried to obtain highly fluorescent solid carbon nanodot particles, as confirmed by spectroscopic analysis.

### Example 2: Characterisation of CDs

### 2.1 SEM Analysis

The size and morphology of the citric acid CDs prepared in Example 1.1 were analysed by SEM, and the results are shown in FIG. 1(a) at 34.14 KX and (b) at 39.28 KX magnification. The SEM images confirm the formation of nanoparticles having an almost spherical shape, and clusters having dimensions of <50 nm.

### 2.2 TEM Analysis

TEM imaging of the citric acid CDs prepared in Example 1.1 was carried out, and the results are shown in FIG. 2 (a). Particle distribution is shown in FIG. 2 (b). The results indicate that the carbon dots have dimensions <10 nm as expected for these nanodot materials.

### 2.3 Spectroscopic Analysis by FTIR, Raman, UV-VIS and Photoluminescence Spectroscopy

FIG. 3 shows the (a) FTIR and (b) Raman analysis of the citric acid based nanodots prepared in Example 1.1. Characteristic FTIR absorption frequencies (FIGS. 3(a)) at 3478, 2930, 1675, 1640, 1540 and 1242 cm⁻¹ confirm the presence of −OH, −CH, −C═O, −C═C— and —C—O—C— groups. FIG. 3(b) demonstrates the characteristic Raman D band (1297 cm⁻¹) and G band (1613 cm⁻¹) clearly indicating the multilayer graphitization due to the presence of carbon nanodots (CDs). The presence of D band indicates the presence of disorder in the graphitic structure.

The UV-VIS spectrum of FIG. 4(a) shows the UV-visible spectrum of citric acid-based CD synthesized at a temperature of 150 °C for 3 h. An absorption peak near 366 nm was observed, due to n-n* transition of the conjugated C═O band; and an absorption band at around 465 nm (with a tail extending into the visible range), ascribed to the n-n* transition of the C═O band.

FIG. 4(b) shows the UV-visible spectrum of orange peel extract-based CD. An absorption peak near 250 nm was observed due to n-n* transition of the conjugated C═C band; and an absorption band at around 355 nm (with a tail extending into the visible range) to the n-n* transition of the C═O band.

FIG. 5 shows the photoluminescence spectra of citric acid-based CDs. A significant feature of CD is their emission wavelength dependent photoluminescence. It is evident from the PL spectrum in FIG. 5 that the intensity of the PL emission of CDs is dependent on the excitation wavelengths at same concentration. The PL spectrum of CD at different excitation wavelengths (340-420) nm are displayed in FIG. 5. It is observed that the strongest PL emission peak was observed at excitation wavelength 360 nm. With increase in excitation wavelength, the emission peak shifted to higher wavelength. The PL behaviour of CD can be attributed to the different particle sizes of CD and presence of various energy traps on surface of CD. With smaller sizes of CD, the energy gap increases and vice versa owing to quantum confinement. Therefore, particles with smaller size are excited at a lower wavelength and larger particles get excited at a higher wavelength. Again, the intensity of the PL is dependent on the number of particles excited at a definite wavelength. In this case, the PL intensity of CD is highest at 360 nm, which specifies that maximum number of particles were excited at 360 nm.

### 2.4 Thermogravimetric Analysis (TGA)

To understand the thermal stability of the CD, samples were analysed by Thermogravimetric analysis (TGA). FIG. 6 shows the thermograms and DTG curves of the CD samples prepared in Example 1.1 (a) and (b), respectively; and in Example 1.2 (c) and (d), respectively.

CD exhibited a two-step thermal degradation pattern. The initial (3-5) % weight loss near (15-120) °C may be assigned to loss of water molecules entrapped between the CD as they contain polar surface groups. The actual initial degradation for CD near 220 °C which is due to the loss of labile oxygen containing functional groups. However, compared to citric acid-based CD, the orange peel-based CD displayed comparatively less weight loss up to 250 °C and exhibited a total weight loss of 68.98 between the temperature range of 30-800 °C.

### Example 3: Preparation of Composite Fillers

Commercial nanoclay Cloisite 30B was modified with citric acid-based CDs and separately with orange peel-based CDs under neutral conditions. 15 g of clay (Cloisite 30B) was taken in a round bottom flask, 3.36 g CD dissolved in 100 ml of water and magnetically stirred for 30 min at 60 °C The thick slurry mixture was poured onto a glass tray and dried under vacuum to obtain a fluorescent CD/Clay composite. The CD modified clays were each observed to be fluorescent under UV light @ 365 nm.

### Example 4: Preparation of Polymer Nanocomposites

### Example 4.1 Melt Processing

Commercial biopolymers such as Polylactic acid (PLA), Polycaprolactone (PCL), Polyhydroxybutyrate (PHB), Cellulose ester (CE), and fossil-based PolyEthylene Terephthalate (PET) and High-Density PolyEthylene (HDPE) were dried in an oven for 5 hr at 80 °C before the blending process. Then, the composites/blends were prepared by melt mixing various polymers with CDs using a lab-scale Brabender melt-mixer at 180 °C and 50 rpm for 6 min. Finally, the processed samples were pressed into 0.1 mm thick sheets using a hydraulic press for further analysis.

### Example 4.2 Solution Casting

PLA composite films were prepared by solvent-casting. Prior to use, the PLA composite (pellets) was dried in oven at 40 °C overnight, to remove any moisture content. 1g PLA/CD-1% was dissolved in 10 ml of chloroform. The solution was stirred for 20 min at room temperature. Similarly, 10% of PLA/CD-Clay, PLA/PCL/CD-CaCO₃, PLA/PCL and PLA pellets in chloroform was prepared. The film forming solutions were cast onto a glass petri dish and allowed to dry at room temperature. Once dried, the cast films were peeled off from the glass plate.

Table 1 shows the various composites/blends prepared in Examples 4.1 and 4.2 above, while their appearance under UV Light is shown in FIG. 7. In all cases, the prepared melt-processed composites all exhibited blue fluorescence under UV light wavelength of 365 nm.

TABLE 1
Effect of CD incorporation on polymer fluorescence.

| | | Fluorescent | |
|---|---|---|---|
| | | under UV | |
| Polymer | Method of | light? | |
| composite film | Preparation | (365 nm) | Observations |
| PLA | Melt | No | Unmodified PLA film is not fluorescent under UV light. |
| | processing | | |
| PLA with 1% CD | Melt | yes | PLA modified with 1% CD was observed to be |
| | processing | | fluorescent under UV light and can be clearly |
| | | | distinguished from its unmodified counterpart which is |
| | | | not fluorescent under UV light. |
| PCL | Melt | No | Unmodified PCL film is not fluorescent under UV light. |
| | processing | | |
| PCL with 1% CD | Melt | yes | PCL modified with 1% CD was observed to be |
| | processing | | fluorescent under UV light and can be clearly |
| | | | distinguished from unmodified PCL under UV light. |
| PHB with 1% CD | Melt | yes | PHB modified with 1% CD was observed to fluorescent |
| | processing | | under UV light and can be clearly distinguished from |
| | | | unmodified PHB under UV light. |
| PBS | Melt | No | Unmodified PBS film is not fluorescent under UV light. |
| | processing | | |
| PBS with 1% CD | Melt | yes | PBS with 1% CD film was observed to be fluorescent |
| | processing | | under UV light and can be clearly distinguished from |
| | | | unmodified PBS under UV light. |
| PET | Melt | No | Unmodified PET film is not fluorescent under UV light. |
| | processing | | |
| PET with 1% CD | Melt | yes | PET modified with 1% CD was observed to be |
| | processing | | fluorescent under UV light, and can be clearly |
| | | | distinguished from unmodified PET under UV light. |
| HDPE | Melt | No | Unmodified HDPE film is not fluorescent under UV light |
| | processing | | . |
| HDPE with 1% CD | Melt | yes | HDPE modified with CD was observed to be fluorescent |
| | processing | | under UV light, and can be clearly distinguished from |
| | | | unmodified HDPE under UV light. |
| PLA80PCL20 | Melt | No | An 80/20 blend of PLA/PCL is not fluorescent under UV |
| | processing | | light. |
| PLA80PCL20 with | Melt | yes | PLA80/PCL20 blend modified with 1% CD was observed |
| 1% CD | processing | | to be fluorescent under UV light and can be clearly |
| | | | distinguished from the unmodified PLA80/PCL20 blend |
| | | | under UV light. |
| PLA80PCL20 with | Melt | yes | PLA80/PCL20 blend modified with 1% CD-Clay was |
| 1% CD-Clay | processing | | observed to be fluorescent under UV light and can be |
| | | | clearly distinguished from its unmodified counterpart |
| | | | under UV light. |
| PLA with 1% CD | Solution | yes | PLA modified with 1% CD was observed to be |
| | casting | | fluorescent under UV light and can be clearly |
| | | | distinguished from its unmodified counterpart which is |
| | | | not fluorescent under UV light. |
| PLA with 1% CD- | Solution | yes | PLA modified with 1% CD-CaCO₃ was observed to be |
| CaCO₃ | casting | | fluorescent under UV light. |
| PLA80PCL20 | Solution | No | An 80/20 blend of PLA/PCL is not fluorescent under UV |
| | casting | | light. |
| PLA80PCL20 with | Solution | yes | PLA/PCL blend modified with CD-CaCO₃ was observed |
| 1% CD-CaCO₃ | casting | | to be fluorescent under UV light. |

All of the polymer and polymer blends tested did not exhibit fluorescence in their unmodified state, but exhibited clearly distinguishable fluorescence under UV light when the CDs were incorporated. These results therefore demonstrate the CDs can be used to fluorescently label polymers, to enable them to be distinguished from non-labelled polymers under UV light. This has a significant number of advantages in identification, sorting and assessment of polymer materials in waste streams.

A limitation of existing spectrometric sorting techniques, such as NIR absorption, is that they typically cannot detect dark-coloured plastics. In order to assess whether the methods of the invention could be applied to dark coloured polymers, polymer materials with different amounts of carbon black were prepared and the fluorescence characteristics of those dark materials in modified (with carbon nanodots) and unmodified (without carbon nanodots) forms were assessed. Similarly, polymer blends with red pigment (Commercial biodegradable pigment supplied by Clariant™ Masterbatches as a gift sample) were prepared in order to assess fluorescence characteristics for coloured polymer materials. The results are shown in Table 2 and FIG. 8.

PLA/PCL composites were also modified with different percentages of carbon black (CB) powder and CD, encoded as PLA/PCL/CB1%, PLA/PCL/CB0.5% CD1%, PLA/PCL/CB0.5% CD0.5%, PLA/PCL/CB2% CD0.5% and PLA/PCL/CB5% CD1% to study the fluorescence behaviour, with PLA/PCL/CB1% was also prepared for comparison purposes. CDs were incorporated directly into the polymers, and incorporated into the polymers comprised in a calcium carbonate-based filler material (*omya55=Omya Smartfill® 55-OM, supplied by SpecialChem™). In the same manner, PLA/PCL composites were modified with 1% red pigment and 1% CD, to determine the fluorescence of composites under UV light (Table 2) and FIG. 8.

TABLE 2
Effect of CD incorporation on polymer fluorescence in dark and coloured polymer materials.

| Polymer | | |
|---|---|---|
| composite film | Fluorescent | |
| PLA/PCL 80/20 | under UV | |
| (0.1 mm | Light? | |
| thickness) | (365 nm) | Observations |
| PLA/PCL/CB1% | No | PLA/PCL/CB1% film is not fluorescent under UV light |
| PLA/PCL/ | yes | PLA/PCL modified with 1% CD and 0.5% CB was observed to be |
| CB0.5% CD1% | | brightly fluorescent blue colour under UV light and can be clearly |
| | | distinguished from PLA/PCL/CB1%. |
| PLA/PCL/CB0.5% | yes | PLA/PCL modified with 0.5% CD and 0.5% CB was observed to be |
| CD0.5% | | an intense fluorescent blue colour under UV light in comparison to |
| | | its pristine counterpart. |
| PLA/PCL/CB2% | yes | PLA/PCL modified with 1% CD and 2% CB was clearly distinguished |
| CD0.5% | | from PLA/PCL modified with 1% CB due to its bright fluorescent |
| | | blue colour. |
| PLA/PCL/CB3% | yes | PLA/PCL modified with 1% CD and 3% CB was bright fluorescent |
| CD1% | | blue colour under UV and clearly distinguished from 1% CB |
| | | modified PLA/PCL film |
| PLA/PCL/CB5% | yes | PLA/PCL modified with 1% CD and 5% CB was observed to be |
| CD1% | | fluorescent under UV light as opposed to PLA/PCL film with 1% CB. |
| PLA/PCL/red1% | yes | PLA/PCL modified with just 1% red pigment shows a reddish |
| | | colour under UV light |
| PLA/PCL/CD1%/ | yes | PLA/PCL modified with 1% CD and 1% red pigment was bright |
| red1% | | fluorescent pink in colour under UV light and clearly distinguished |
| | | from 1% red pigment modified PLA/PCL film, which still appears a |
| | | reddish colour under UV light. |
| PLA/PCL/CD- | yes | PLA/PCL modified with 1% CD-omya55* and 1% red pigment was |
| omya551%/red1% | | bright fluorescent pink in colour under UV light and clearly |
| | | distinguished from PLA/PCL film modified with 1% red pigment. |

### Example 5: Mechanical Testing of Polymer Composites

1 mm thick sheets of composites and blends of bioplastics were prepared with 1 wt. % of CD to understand the effect of CD on the mechanical properties of the composites. The mechanical properties of the composites prepared were measured as follows:

The composite sheets were punched with a cutter to dumbbell-shaped samples with dimensions of 75 mm×4 mm×1 for stress-strain measurements. Tensile measurements were carried out using a Zwick twin column tensile tester (ZwickRoell™, Kennesaw, GA, USA) with a 2.5 kN load cell. The tensile tests were carried out at room temperature and a cross head speed of 50 mm/min. Young's modulus, ultimate tensile strength, breaking strength, elongation at break and toughness values were calculated by integrating the stress-strain data obtained from the samples.

The results of the mechanical testing are presented in Table 3.

TABLE 3
Mechanical properties of composites.

| Neat | Tensile | | Young's | |
|---|---|---|---|---|
| polymer/Polymer | Strength | Elongation | modulus | Toughness |
| composites | (MPa) | at break (%) | (GPa) | (MJ/m3) |
| PLA | 65.72 ± 28.57 | 4.288 ± 0.6 | 1.944 ± 0.80 | 1.66 ± 0.477 |
| PLA with 1% CD | 74.532 ± 1.02 | 4.6075 ± 0.44 | 1.926 ± 0.03 | 1.918 ± 0.22 |
| PCL | 52.23 ± 2.06 | 1208.16 ± 32.60 | 0.226 ± | 344.86 ± 13.83 |
| PCL with 1% CD | 49.69 ± 0.90 | 1171.3 ± 30.71 | 0.238 ± 0.01 | 331.40 ± 12.40 |
| PLA80/PCL20 | 53.97 ± 0.52 | 233.35 ± 19.81 | 1.40 ± 0.12 | 83.38 ± 9.89 |
| PLA80/PCL20/CD | 48.87 ± 0.84 | 235.02 ± 10.82 | 1.42 ± 0.01 | 77.38 ± 6 |
| PLA70/PCL30 | 45.5 ± 0.84 | 221.32 ± 22 | 1.18 ± 0.11 | 72 ± 8.44 |
| PLA70/PCL30/CD | 39.514 ± 0.48 | 244.94 ± 8.81 | 3.2275 ± 3.67 | 72.506 ± 2.63 |

It is observed that there is an increase in tensile strength with the incorporation of 1% CD in PLA. However, no significant change in the mechanical properties was observed with other composites.

### Example 6: Estimation of Recycled Content in Composites Using CD

PLA master-batch with 10% fluorescent carbon nanodots was prepared using a lab scale Brabender mixer. Then, various amounts of MB were melt-processed with pure PLA, and the composites were pressed into 0.1 mm sheets and analysed using a UV spectrophotometer. FIG. 9 shows the UV absorbance for PLA composites with various amounts of MB.

From the UV absorbance plots, it is evident that with an increase in the MB content, increased absorbance of the composites was observed at 357 nm wavelength. The change in the UV absorbance is directly related to the amount of CD present in the MB. Therefore, this change in absorbance can be co-related to the amount of the nano-dot containing masterbatch in the composite. Similarly, MB prepared with fossil-based HDPE and composites were prepared with various amounts of masterbatch, and the composite films were analysed by UV spectroscopy. FIG. 10 shows UV absorbance plot for these HDPE composites.

These results demonstrate that the fluorescent carbon nanodots can be used to label polymers in order to estimate the amount of that labelled polymer in a composite material. For instance, if the labelled polymer is a biodegradable or recycled polymer, the method can be used to estimate the amount of biodegradable or recycled content of that material. Similarly, the method could be used to assess the biodegradable or recycled content in a mixed waste stream, for instance by first separating the labelled material from the waste stream and then assessing the recycled content by spectroscopic analysis.

### Example 7: Industrial Composting of Composites

The preferred waste management for most biodegradable plastics is industrial composting. To assess the effect of CD on the compostability of the composites, PLA, PLA/CD, PCL, PLA/PCL and PLA/PCL/CD composites were evaluated for their disintegration in an industrial composting facility in accordance with standard EN13432 (certified Bioplastics Performance in Industrial Composting). The tests were done for duplicates or triplicates for each film. The results of the test are presented in Table 4. Preliminary results indicated that the presence of the carbon nanodots increases the rate of biodegradation.

TABLE 4
Compostability of carbon nanodot-containing polymers.

| | | | | Less than | |
|---|---|---|---|---|---|
| | | | % of film | 10% of film | |
| | Initial | Final | left in | remaining | |
| Sample | weight (g) | weight (g) | the compost | after trial | Pass/Fail |
| PLA | 0.65/1.14/1.17 | 0/0/0.005 | 0/0/0.42% | Yes | pass/pass/pass |
| PLA/CD | 0.69/0.72/0.78 | 0.01/0/0 | 1.45%/0/0 | Yes | pass/pass/pass |
| PCL | 1.08/1.1/1.12 | 0/0/0.008 | 0/0/0.71% | Yes | pass/pass/pass |
| PLA/PCL | 0.41/0.38 | Not available | Yes | Yes | pass/pass |
| PLA/PCL/CD | 0.78/0.79/0.78 | 0.002/0/0 | 0.25%/0/0 | Yes | pass/pass/pass |

### Example 8: Cytotoxicity Studies

The preliminary cytotoxicity of the virgin carbon dots and inorganic fillers modified with CDs as prepared in Example 3, were evaluated using 3 different cell types. 1) HEK293T cell line exhibiting epithelial morphology that was isolated from the kidney of a human embryo. This human cell line is a useful tool for toxicology research. 2) HEPG2 cell line exhibiting epithelial-like morphology that was isolated from a hepatocellular carcinoma of a 15-year-old, White, male youth with liver cancer. 3) Human primary peripheral blood lymphocyte T-cells (PBTL), isolated from healthy volunteers and activated in vitro. All the cell types were cultured in recommended cell culture medium and supplements.

Cells (2,000 cells/well for HEK293T and HEPG2 cells and 10,000 cells/well for PBTL in 96 well-plates) were treated with increasing concentration of the clay particles-1 μg/mL, 5 μg/mL, 10 μg/mL, 25 μg/mL, 50 μg/mL, 100 μg/mL, or 250 μg/mL (dispersed in cell culture medium) for 24 h. Total volume of the cell culture medium was maintained at 100 μL/well. After this time, and cell viability was quantified using CellTiter 96® AQueous One Solution Cell Proliferation Assay (MTS) kit (Promega) as per the manufacturer's instructions. This is a sensitive colorimetric-based assay that uses a single ready-to-use MTS reagent [3-(4,5-dimethylthiazol-2-yl)-5-(3-carboxymethoxyphenyl)-2-(4-sulfophenyl)-2H-tetrazolium] for determining the number of viable cells in proliferation. Viable mammalian cells reduce the MTS compound to a colored formazan dye, which is quantified by measuring the absorbance at 490 nm. The quantity of formazan product is directly proportional to the number of living cells in culture. To determine the effect of carbon dots/modified carbon dots on cell viability, MTS solution (20 μL) was added to each well in 96-well plates containing carbon dot-treated (or untreated control) cells in 100 μl medium. Plates were incubated further for 2 h and then absorbance was recorded at 490 nm using a 96-well plate reader. Percentage cell viability was calculated against control and plotted. Inhibitory concentration 50% IC₅₀ of each carbon dots/modified carbon dots was calculated using GraphPad Prism.

Table 5 shows the cytotoxicity of the virgin and modified carbons dots against various cell lines. From the data, it is evident that carbon dots made from citric acid and orange peel are non-toxic for the three different cell types (cell lines as well as primary T-cells) evaluated. The carbon dots modified with Cloisite 30B are toxic beyond a certain concentration, however they are non-toxic at the lower concentrations required to impart fluorescent characteristics on the polymers. Calcium carbonate as a filler material was found to be non-toxic in all tests performed.

TABLE 5
Cytotoxicity of the virgin and modified
carbons dots against various cell lines.

| | Inhibitory Concentration (IC50) | | | |
|---|---|---|---|---|
| | (50% cell death) of Cell type | | | |
| | HEK293T | PBTL | HepG2 | |
| | IC50 | IC₅₀ | IC₅₀ | |
| Compound | (μg/ml) | (μg/ml) | (μg/ml) | Comments |
| Orange Peel- | >250 | >250 | >250 | Non-toxic |
| based carbon | | | | |
| dots (CD) | | | | |
| Citric acid-based | >250 | >250 | >250 | Non-toxic |
| carbon dots | | | | |
| Citric acid CD- | 103.6 | 6.83 | 101.3 | Partially |
| Cloisite 30B | | | | toxic |
| Orange peel- | 91.32 | 24.87 | 6.63 | Partially |
| based CD- | | | | toxic |
| Cloisite 30B at | | | | |
| neutral pH | | | | |
| Orange peel- | 78.52 | 24.29 | 12.76 | Partially |
| based CD- | | | | toxic |
| Cloisite 30B at | | | | |
| acidic pH | | | | |
| Orange peel- | 99.38 | 24.98 | 18.01 | Partially |
| based CD- | | | | toxic |
| Cloisite 30B at | | | | |
| basic pH | | | | |
| Orange peel- | >250 | >250 | >250 | Non-toxic |
| based CD- | | | | |
| calcium | | | | |
| carbonate at | | | | |
| neutral pH | | | | |
| Orange peel- | >250 | >250 | >250 | Non-toxic |
| based CD- | | | | |
| calcium | | | | |
| carbonate at | | | | |
| acidic pH | | | | |
| Orange peel- | >250 | >250 | >250 | Non-toxic |
| based CD- | | | | |
| calcium | | | | |
| carbonate at | | | | |
| basic pH | | | | |
| Orange peel- | >250 | >250 | >250 | Non-toxic |
| based CD- | | | | |
| Halloysite clay | | | | |
| Orange peel- | >250 | >250 | >250 | Non-toxic |
| based CD- | | | | |
| montmorillonite | | | | |
| clay | | | | |
| Orange peel- | >250 | >250 | >250 | Non-toxic |
| based CD- | | | | |
| calcium | | | | |
| carbonate | | | | |
| Orange peel- | 139.8 | 25.90 | 20.07 | Partially |
| based CD- | | | | toxic |
| Cloisite 30B | | | | |

### Example 9: Segregation of Mixed Plastic Waste

Segregation of plastic waste is more important than ever to increase the reuse of plastic products and reduce the environmental impact of plastic materials. In order to understand the segregation of biodegradable polymer composites from mixed plastic waste, a small-scale sorting trial was conducted using a Picvisa NIR (Near Infrared) sorting machine. To perform the sorting trials, 1 kg of non-biodegradable mixed plastic waste collected from the roadside (consisting of polyethylene, PET, polypropylene, polystyrene, paper, wood, etc) was mixed with 1 kg of biodegradable polymer composites. The NIR Spectrophotometer was programmed to eject the biodegradable polymer composites from mixed plastic waste to understand the efficiency of the segregation of biodegradable plastics. The segregation efficiency of three biodegradable polymer composite sample films, namely PLA, PLA80PCL20 and PLA80PCL20 with 1% CD-CaCO₃, was evaluated by passing the material through the NIR sorter at a steady speed. Segregation efficiency was calculated by weighing the material recovered at the end of each run, with each runs being performed in duplicate. Table 6 shows the percentage of recovery of the polymers from mixed plastic waste.

TABLE 6
Segregation of polymers from mixed waste.

| | Amount of | Sorted | |
|---|---|---|---|
| | polymer in | plastic | |
| Polymer | mixed plastic | from mixed | |
| composite film | waste (Kg) | waste (Kg) | % Segregation |
| PLA | 1 | 0.66 | 66 |
| PLA80PCL20 | 1 | 0.65 | 65 |
| PLA80PCL20 with | 1 | 0.98 | 98 |
| 1% CD-CaCO₃ | | | |

The segregation trials showed that composites containing the CD-CaCO₃ showed significantly improved segregation efficiency compared to other biodegradable polymer composites.

1. A method of preparing a fluorescent labelled polymer, the method comprising
providing fluorescent carbon nanodots, and
incorporating the fluorescent carbon nanodots into the polymer, wherein the fluorescent carbon nanodots are prepared from a natural or recoverable resource,
wherein the fluorescent carbon nanodots are incorporated into the polymer by melt processing, or in-situ polymerisation.

2. (canceled)

3. The method as claimed in claim 1, wherein the fluorescent carbon nanodots are mixed with an organic or inorganic filler material before being incorporated into the polymer.

4. The method as claimed in claim 1, wherein the natural or recoverable resource is selected from fruit peels, plant leaves, plant extracts, plant fronds or husks, or the natural or recoverable resource is terephthalic acid or Delactosed Whey Permeate (DLP).

5. (canceled)

6. (canceled)

7. (canceled)

8. The method as claimed in claim 1, wherein the polymer is a biopolymer.

9. The method as claimed in claim 8, wherein the biopolymer is selected from polylactic acid, polybutylene succinate, polyhydroxy butyrate, polybutylene succinate adipate, polytrimethylene terephthalate, bio-polyethene, homopolymides, copolyimide and polyurethanes.

10. A fluorescent labelled polymer, wherein the fluorescent labelled polymer comprises fluorescent carbon nanodots prepared from a natural or recoverable resource, and wherein the polymer is a biopolymer.

11. The fluorescent labelled polymer as claimed in claim 10, wherein the natural or recoverable resource is selected from fruit peels, plant leaves, plant extracts, plant fronds or husks, or the natural or recoverable resource is terephthalic acid or Delactosed Whey Permeate (DLP).

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. The fluorescent labelled polymer as claimed in claim 10, wherein the biopolymer is selected from polylactic acid (PLA), polybutylene succinate (PBS), polyhydroxy butyrate (PHBV), Poly(butylene succinate-co-butylene adipate) (PBSA), and poly caprolactone (PCL).

26. The method as claimed in claim 1, wherein the inorganic material is selected from calcium carbonate, talc, mica, kaolin, magnesium hydroxide, wollastonite (CaSiO₃), silica, zinc oxide, titanium oxide, iron oxide, magnesium carbonate, Polyhedral oligomeric silsesquioxanes (POSS), zinc carbonate, calcium sulphate, graphene, hexagonal boron nitride (hBN), or a nanoclay composite

27. A method of identifying a polymer, the method comprising exposing a fluorescent labelled polymer to UV light, and visualising the fluorescence emitted by the naked eye or via spectrometry;
wherein the fluorescent labelled polymer comprises fluorescent carbon nanodots prepared from a natural or recoverable resource.

28. The method of claim 27, wherein the method comprises identifying a polymer in a mixed waste stream.

29. The method of claim 27, wherein the polymer is a biopolymer.

30. The method as claimed in claim 29, wherein the biopolymer is selected from polylactic acid (PLA), polybutylene succinate (PBS), polyhydroxy butyrate (PHBV), Poly(butylene succinate-co-butylene adipate) (PBSA), and poly caprolactone (PCL).

31. The method as claimed in claim 27, wherein the natural or recoverable resource is selected from fruit peels, plant leaves, plant extracts, plant fronds or husks, or the natural or recoverable resource is terephthalic acid or Delactosed Whey Permeate (DLP).

32. The method as claimed in claim 27, wherein the natural or recoverable resource is selected from citric acid, orange peel extract, terephthalic acid and Delactosed Whey Permeate (DLP).

33. The method of claim 28, wherein the method is a method of assessing the naturally-derived or recoverable content of a polymer, wherein the method further comprises the step of comparing the absorbance spectrum with a control spectrum to assess the labelled content.

34. The method of claim 33, wherein the method comprises exposing a mixture of fluorescent labelled polymers to UV light.

35. The method as claimed in claim 33, wherein the fluorescent labelled polymer is a biopolymer, and comparing the absorbance spectrum with a control spectrum gives an assessment of the biodegradable content.

36. The method as claimed in claim 35, wherein the biopolymer is selected from polylactic acid (PLA), polybutylene succinate (PBS), polyhydroxy butyrate (PHBV), Poly(butylene succinate-co-butylene adipate) (PBSA), and poly caprolactone (PCL).

37. The method as claimed in claim 33, wherein the natural or recoverable resource is selected from fruit peels, plant leaves, plant extracts, plant fronds or husks, or the natural or recoverable resource is terephthalic acid or Delactosed Whey Permeate (DLP).
